(19) United States
(12) Patent Application Publication
(10) Pub. No.: US 2008/0196152 A1
(43) Pub. Date: Aug. 21, 2008

(54) PORTABLE COLLAPSIBLE SAUNA SYSTEM

(75) Inventor: Juan Jose Campdera Lozano, Barcelona (ES)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(73) Assignee: Hopson (H. K.) Limited, Wanchai (HK)

(21) Appl. No.: 11/675,387

(22) Filed: Feb. 15, 2007

(51) Int. Cl. A61H 33/06

(52) U.S. Cl. 4/527

(57) ABSTRACT

A portable collapsible sauna system that includes a flexible collapsible lightweight shell that cooperates with a flexurally resilient frame to define an interior volume sufficiently large to receive a person therein, preferably in a seated position. A steamer generates steam which is communicated into the interior volume. The frame is preferably comprised of flexurally resilient, shape-memory elements that permit the structure to collapse into a compact position for traveling and storage.

### BACKGROUND

The prior art is replete with various types of collapsible sauna systems. While each of the prior art sauna systems may serve its intended purpose, a need remains for collapsible sauna system that is lightweight, yet sturdy, and which can collapse into a compact position for traveling and storage.

### SUMMARY

The present invention is directed to a portable collapsible sauna system that includes a flexible collapsible lightweight shell that cooperates with a flexurally resilient frame to define an interior volume sufficiently large to receive a person therein, preferably in a seated position. A steamer generates steam which is communicated into the interior volume. The frame is preferably comprised of flexurally resilient, shape-memory elements that permit the structure to collapse into a compact position for traveling and storage.

### BRIEF DESCRIPTION OF THE DRAWINGS

FIG. 1 is a perspective view of an embodiment of a portable collapsible sauna system in accordance with the present invention shown in the expanded working position.

FIG. 2 is a perspective view of the collapsible sauna system of FIG. 1 shown in a compact storage position.

FIG. 3 is a perspective view of the collapsible sauna system of FIG. 1 showing a preferred embodiment of the frame in the expanded position with the shell shown in phantom lines for clarity.

FIG. 4 is a perspective view of the frame and shell of FIG. 3 collapsed into a flat storage position.

FIGS. 5 and 6 illustrate one example of how the frame and shell structure may be further collapsed from the flat storage position illustrated in FIG. 4 to a more compact storage position as illustrated in FIG. 2.

### DETAILED DESCRIPTION

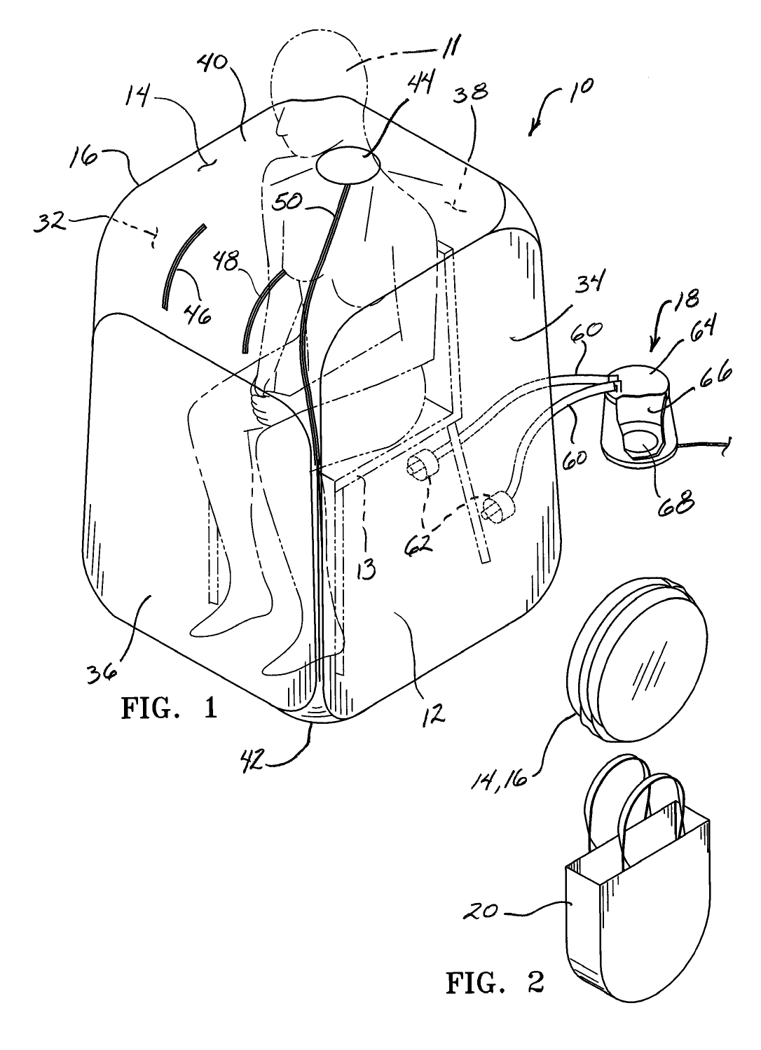

Referring now to the drawings wherein like reference numerals designate identical or corresponding parts throughout the several views, FIG. 1 illustrates one embodiment of a portable collapsible sauna system 10 of the present invention shown in an expanded or working position. The portable collapsible sauna system 10 includes a flexible collapsible shell 14 that cooperates with a flexurally resilient, collapsible frame 16 (FIG. 3) which cooperate to define an interior volume 12. A steamer 18 is provided to generate steam which is communicated into the interior volume 12.

In FIG. 1, a person is illustrated sitting within the interior volume 12 on a chair 13. It should be appreciated, however, that although in the preferred embodiment the shell and frame structure is sized and arranged to accommodate a person sitting on a chair, the structure may also be sized and arranged to accommodate a person in the standing or laying position.

FIG. 2 illustrates the frame and shell structure collapsed into a preferred compact storage position. A bag or carrying case 20 is preferably provided into which the collapsed structure may be inserted for storage and transportation. Furthermore, as will be discussed in detail later, because the flexurally resilient, collapsible frame 16 preferably comprises a plurality of shape memory elements 22, 24, 26, 28 which are biased in a normally expanded position as best illustrated in FIG. 3, the bag 20 serves to maintain the normally expanded resilient frame elements 22, 24, 26, 28 in the compact storage position.

The shell 14 is preferably comprised of nylon or other light-weight, yet sturdy, material that is quick to dry and is easily collapsible such that it will lay substantially flat. The shell preferably includes six panels, left and right side panels 32, 34, front and back panels 36, 38, and top and bottom panels 40, 42. An opening 44 is preferably provided in the top panel 40 through which the user's neck may extend. Additionally, in the preferred embodiment, two hand openings 46, 48 are preferably provided through which the user's hands may extend.

In the preferred embodiment an access opening 50 is provided to permit the user to gain access to the interior volume 12. As best viewed in FIG. 1, the access opening preferably extends from the neck opening 44 down along one side of the front panel 36 between the front frame member 22 and an adjacent side frame member 24, thereby permitting one side of the front panel 36 to move away from the adjacent side wall 34, thereby forming a door through which the user can conveniently step into and out of the interior volume 12. A zipper is preferably provided to open and close the access opening 50 from the exterior or from the interior. Although a zipper is preferred, other means for removably securing the shell together between adjacent side panels may also be used, including Velcro®, snaps, buttons, etc. The zipper preferably includes an exterior and an interior tab for pulling the zipper open and closed. However, if for some reason the interior zipper tab is not provided or if it breaks, the user may extend one or both of his/her arms through the hand openings 46, 48 to grasp the exterior zipper tab to pull the zipper open or closed. The hand openings 46, 48 are also preferably provided with zippers or other fastening means to allow the user to close the hand openings 46, 48 when the sauna is in use to prevent the unwanted escape of steam.

As previously discussed, in the preferred embodiment, the vertical height of the side panels 32, 34 and the rear panel 38 are preferably within the typical height range of the neck of an adult person when in the seated position. The front panel 36 is preferably shorter than the side and back panels 32, 34, 38 thereby allowing the hand openings 46, 48 to be placed at a more convenient position and without interference with the front frame element 22.

Steam generated by the steamer 18 is preferably communicated by pipes or tubes 60 into the interior volume 12 through one or more ports or sleeves 62 in one of the wall panels 32, 34, 36, 38 of the shell 14. The steamer 18 may be any suitable apparatus that is capable of generating steam and may be powered by any conventional or available power source. In the preferred embodiment, the steamer 18 includes a removable top cover 64 that is removed for pouring a supply of water into the interior reservoir 66. A suitable heating element 68 is provided to heat the water within the reservoir 66 to generate the steam. The generated steam escapes from ports through the top cover and is communicated by the tubes 60 into the interior volume.

As best illustrated in FIG. 3, and as previously identified, the flexurally resilient collapsible frame 16 preferably comprises a plurality of shape memory elements 22, 24, 26, 28 that are biased in a normally expanded position. In the preferred embodiment these shape memory elements 22, 24, 26, 28 are preferably rectangular shaped hoops that define the preferred substantially vertical, upright wall panels of the structure. It should be appreciated that although the preferred frame 16 is illustrated as comprising four rectangular hoop elements, an equally suitable structure may be formed from three or more elements of any desired polygonal shape. As illustrated in FIG. 3, the preferred hoop elements are also preferably rectangular in cross section. The preferred rectangular cross-sectional configuration of the shape-memory hoop elements facilitates the biasing of the hoop elements in their preferred normally expanded position. However, other cross-sectional shapes may be equally suitable for the shape memory elements. The preferred hoop elements may be constructed from steel, plastic, composites or any other suitable flexurally resilient material.

Referring now to FIGS. 3-6, in the preferred embodiment, the structure of the collapsible sauna system 10 may be collapsed to a flat position as illustrated in FIG. 4 by pushing one corner (“A”) of the frame 16 inward toward an opposite diagonal corner (“B”), for example, thereby causing the hoop elements 22, 24, 26, 28 to fold in on one another into a stack, with the flexible shell 14 collapsed between adjacently stacked elements. The structure may be stored in this flat position, if desired, but preferably, the structure is further collapsible into a more compact storage position as illustrated in FIG. 2.

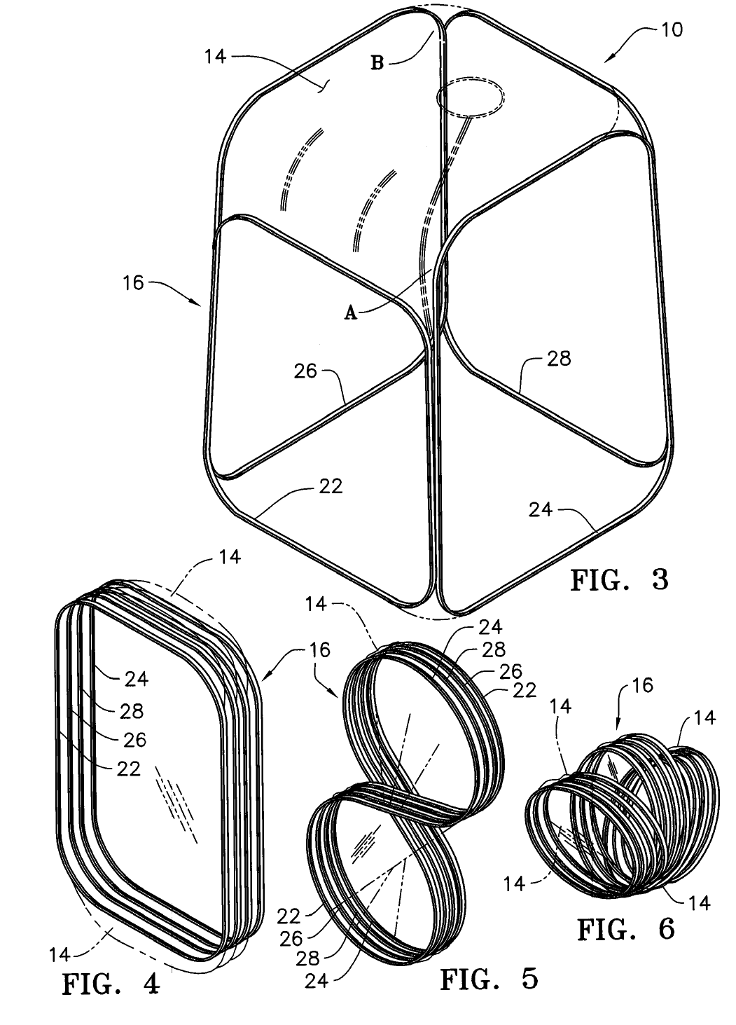

To further collapse the structure from the flat position (FIG. 4) to the more compact position (FIG. 2), opposing sides of the stacked hoop elements are grasped and twisted in opposite directions to form a figure-8 as illustrated in FIG. 5. Next, by continuing to twist the hoops while bringing the ends of the figure-8 together, the hoops will continue to flex and will eventually form a nest of three interconnected coil sets as illustrated in FIG. 6, with the shell 14 collapsed and twisted between adjacent stacked coils.

It should be appreciated that because the preferred frame is comprised of a plurality of shape memory hoop elements 22, 24, 26, 28, each of which is biased in a normally expanded position, if the force used to coil the frame and shell structure into the compact position of FIG. 6 is released, the hoop elements 22, 24, 26, 28 will spring-back to their normally expanded rectangular hoop position as illustrated in FIG. 4. Thus, as previously identified, to maintain the frame and shell structure in the preferred coiled compact storage position, a bag or carrying case 20 is provided in which the coiled structure is inserted.

It should be appreciated that various shapes and arrangements of shape memory frame elements may be provided, each of which may be flexed, twisted or otherwise manipulated into compact storage positions wherein the exterior periphery of the structure while in the compact storage position is less than the exterior periphery of any dimension of the frame structure when in its normally expanded position.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A portable collapsible sauna system, comprising:
a steamer for generating steam;
a flexible collapsible shell;
a flexurally resilient frame cooperating with said shell to define an interior volume sufficiently large to receive an average sized adult therein, said flexurally resilient frame comprising a plurality of collapsible frame elements biased in a normally expanded position;
an access opening in said shell through which said average sized adult may enter said interior volume;
at least one port in said shell through which said steam is communicated into said interior volume;
wherein said shell and said flexurally resilient frame is collapsible from a flat collapsed position into a more compact storage position having an outer periphery less than an outer peripheral dimension of said frame when in said flat collapsed position.

2. The portable collapsible sauna system of claim 1 comprising at least three collapsible frame elements.

3. The portable collapsible sauna system of claim 2 wherein said collapsible frame elements are closed hoops.

4. The portable collapsible sauna system of claim 3 wherein said closed hoops are substantially rectangular, rounded corner, hoops.

5. The portable collapsible sauna system of claim 1 wherein a neck opening is disposed in a top panel of said shell through which said average sized adult's neck may extend.

6. The portable collapsible sauna system of claim 5 wherein said access opening includes a means for opening and closing said opening from said interior volume.

7. The portable collapsible sauna system from claim 6 further including at least one hand opening disposed in said shell through which said averaged sized adult's hands may extend.

8. The portable collapsible sauna system from claim 7 wherein said at least one hand opening includes a means for opening and closing said at least one hand opening from said interior volume.

9. The portable collapsible sauna system of claim 1 comprising four collapsible frame elements.

10. The portable collapsible sauna system of claim 9 wherein at least three of said four collapsible frame elements define substantially vertical wall panels having a vertical height corresponding to a vertical height within a typical height range of a neck of said average adult when in a seated position.

11. The portable collapsible sauna system of claim 10 wherein a fourth one of said four collapsible frame elements has a height less than said other three frame elements.

12. The portable collapsible sauna system of claim 11 wherein said access opening extends from said neck opening in a top panel of said shell between adjacent collapsible frame elements.

13. The portable collapsible sauna system of claim 11 wherein said collapsible frame elements are closed hoops.

14. The portable collapsible sauna system of claim 13 wherein said closed hoops are substantially rectangular, rounded corner, hoops.

15. The portable collapsible sauna system of claim 13 wherein a neck opening is disposed in a top panel of said shell through which said average sized adult's neck may extend.

16. The portable collapsible sauna system of claim 15 wherein said access opening includes means for opening and closing said opening from said interior volume.

17. The portable collapsible sauna system from claim 16 further including at least one hand opening disposed in said shell through which said averaged sized adult's hands may extend.

18. The portable collapsible sauna system from claim 17 wherein said at least one hand opening includes a means for opening and closing said at least one hand opening from said interior volume.
